(19) United States
(12) Patent Application Publication
(10) Pub. No.: US 2025/0380152 A1
(43) Pub. Date: Dec. 11, 2025

(54) COMMUNICATION METHOD AND APPARATUS

(71) Applicant: HUAWEI TECHNOLOGIES CO., LTD., Shenzhen (CN)

(72) Inventors: Chuili Kong, Hangzhou (CN); Yu Wang, Hangzhou (CN)

(73) Assignee: HUAWEI TECHNOLOGIES CO., LTD., Shenzhen (CN)

(21) Appl. No.: 19/311,308

(22) Filed: Aug. 27, 2025

Related U.S. Application Data
(63) Continuation of application No. PCT/CN2024/078758, filed on Feb. 27, 2024.

(30) Foreign Application Priority Data
Feb. 28, 2023 (CN) 202310232887.6

(51) Int. Cl. H04W 16/28; H04W 72/30; H04W 84/06

(52) U.S. Cl. CPC H04W 16/28; H04W 72/30; H04W 84/06

(57) ABSTRACT

This application pertains to the field of communication technologies, and provides a communication method and apparatus, to ensure accuracy of beam position scheduling by accurately addressing each beam position. In the method, a terminal sends first beam position information that is level information, so that the first beam position information can indicate a unique beam position. In this way, each beam position is accurately addressed, to ensure that a first network device can accurately schedule the beam position.

### CROSS-REFERENCE TO RELATED APPLICATIONS

This application is a continuation of International Application No. PCT/CN2024/078758, filed on Feb. 27, 2024, which claims priority to Chinese Patent Application No. 202310232887.6, filed on Feb. 28, 2023. The disclosures of the aforementioned applications are hereby incorporated by reference in their entireties.

### TECHNICAL FIELD

This application relates to the communication field, and in particular, to a communication method and apparatus.

### BACKGROUND

A low earth orbit (LEO) satellite can implement global coverage in a constellation of a specific scale, and one manner of implementing global coverage is to perform coverage based on a beam position, that is, a fixed beam position is obtained through division on the ground. The beam position is a position covered by a beam emitted by a satellite antenna at an angle in an azimuth or a pitch, and a size of the beam position needs to be determined based on factors such as a size and a capability of a phased array. Division into beam positions is dividing the surface of the earth into beam positions of a same size or different sizes based on the determined size of the beam position for a same specific satellite system. After the division into beam positions is completed, each beam position needs to be addressed to assist in subsequent beam position scheduling.

However, if addressing on the beam position is not accurate enough, accuracy of beam position scheduling is affected. Therefore, how to accurately address the beam position is a hot issue in current research.

### SUMMARY

Embodiments of this application provide a communication method and apparatus, to ensure accuracy of beam position scheduling by accurately addressing each beam position.

To achieve the foregoing objective, the following technical solutions are used in this application.

According to a first aspect, a communication method is provided, and is performed by a terminal. The method includes: A terminal obtains first beam position information, and sends the first beam position information to a first network device. The first beam position information includes N-level information in M-level information indicating a first beam position, i^{th}-level information in the M-level information indicates an i^{th}-level area, (i+1)^{th}-level information in the M-level information indicates an (i+1)^{th}-level area, M is an integer greater than 1, N is an integer less than or equal to M, i is any integer from 1 to M-1, the i^{th}-level area includes the (i+1)^{th}-level area, the (i+1)^{th}-level area includes the first beam position, and the first beam position includes a beam position in which the terminal is located or a beam position to which the terminal is capable of moving. An area covered by a beam of the first network device includes the first beam position.

It can be learned from the method according to the first aspect that, because the first beam position information reported by the terminal is level information, for example, level division is performed on beam positions through M-level areas having an inclusion relationship. Therefore, an M^{th}-level area covered by the beam position determined by the first network device based on the first beam position information can be uniquely indicated. In other words, the beam position determined based on the first beam position information is also unique, so that each beam position is accurately addressed, and it is ensured that the first network device can accurately schedule the beam position.

In some embodiments, that the terminal sends the first beam position information to the first network device includes: The terminal sends the first beam position information to the first network device when the terminal determines that the terminal has moved to the first beam position or the terminal is capable of moving to the first beam position. In other words, after the beam position of the terminal changes, for example, after the terminal moves from a beam position A to a beam position B, the terminal may send, to the first network device in time, the first beam position information of the beam position in which the terminal is currently located, so that the first network device can perform scheduling in time, to avoid a scheduling error. In addition, the beam position to which the terminal is capable of moving may be a beam position adjacent (for example, directly adjacent or indirectly adjacent) to the beam position in which the terminal is located. In this way, the terminal sends the first beam position information to the first network device, so that the first network device can prepare for handover of the terminal in advance, thereby ensuring timeliness of the handover.

In some embodiments, that the terminal sends the first beam position information to the first network device includes: The terminal sends the first beam position information to the first network device when the terminal determines that the terminal needs to obtain a service of the first network device, to ensure that the first network device can provide the service for the terminal in time.

In some embodiments, that the terminal obtains the first beam position information includes: The terminal receives the first beam position information broadcast by the first network device.

Alternatively, in some embodiments, that the terminal obtains the first beam position information includes: The terminal receives area information from the first network device, to determine the first beam position information based on the area information and a position of the terminal and according to a preset rule. The area information is used to determine the area covered by the beam of the first network device, and the preset rule indicates that beam positions in the area covered by the beam of the first network device are obtained through division based on M-level areas.

Alternatively, in some embodiments, that the terminal obtains the first beam position information includes: The terminal receives beam position set information from the first network device, and the terminal determines the first beam position information based on the position distribution of the plurality of beam positions in the beam position set information and a position of the terminal. The beam position set information indicates position distribution of a plurality of beam positions, and the first beam position belongs to the plurality of beam positions. In this way, after receiving the beam position set information, the terminal can determine the first beam position information only based on the information and the position of the terminal. In this way, it can be avoided that beam position information of all beam positions is stored for the terminal in advance, thereby reducing use of storage space of the terminal.

It can be learned that, when the first beam position information is not preconfigured in the terminal, the first network device may send the first beam position information; or when the terminal may obtain the first beam position information based on the area information and the position of the terminal and according to the preset rule, the first network device may send the area information; or when the terminal may obtain the first beam position information based on the position distribution of the plurality of beam positions and the position of the terminal, the first network device may further send the beam position set information. In other words, for different requirements of the terminal, the first network device may provide information corresponding to the requirements, to ensure that the terminal can obtain the first beam position information, so as to implement flexible application to various actual scenarios. In addition, because the first beam position information is determined based on the information sent by the first network device, the beam position information does not need to be locally preconfigured in the terminal, so that storage overheads of the terminal can be reduced to some extent, and utilization of the storage space of the terminal can be improved.

In some embodiments, areas at a same level that include any two of the plurality of beam positions have a same size, to implement more convenient and efficient division into beam positions.

In some embodiments, areas at a same level that include any two of the plurality of beam positions have different sizes, to implement division into beam positions more flexibly based on an actual situation.

According to a second aspect, a communication method is provided, and is performed by a first network device. The method includes: A first network device receives first beam position information from a terminal, and stores the first beam position information. The first beam position information includes N-level information in M-level information indicating a first beam position, i^{th}-level information in the M-level information indicates an i^{th}-level area, (i+1)^{th}-level information in the M-level information indicates an (i+1)^{th}-level area, M is an integer greater than 1, N is an integer less than or equal to M, i is any integer from 1 to M-1, the i^{th}-level area includes the (i+1)^{th}-level area, the (i+1)^{th}-level area includes the first beam position, and the first beam position includes a beam position in which the terminal is located or a beam position to which the terminal is capable of moving.

In some embodiments, the method according to the second aspect may further include: The first network device sends the first beam position information to a third network device when an area covered by a beam of a second network device overlaps the first beam position. The third network device and the second network device are a same device, or the third network device is configured to schedule the second network device. It may be understood that the beam position indicated by the first beam position information is usually unique. Therefore, the third network device can directly and uniquely determine, based on the first beam position information, that a beam indicated by the first beam position information is a beam position that may be subject to interference of the third network device, to adjust a service of the third network device and avoid interference.

In some embodiments, the method according to the second aspect may further include: The first network device sends position information of the first network device to the third network device. It may be understood that there may be a plurality of beam positions indicated by the first beam position information. However, the first network device can further send the position information of the first network device. Therefore, even if there are the plurality of beam positions indicated by the first beam position information, the third network device can still uniquely determine, based on the position information of the first network device, that a beam position indicated by the first beam position information is a beam position that may be subject to interference of the second network device, to adjust a service of the third network device and avoid interference.

Further, that the first network device sends the position information of the first network device to the third network device includes: The first network device sends the position information of the first network device to the third network device when the first beam position information indicates that there are a plurality of first beam positions, so that the third network device can uniquely determine, based on the position information of the first network device, that a beam position indicated by the first beam position information is a beam position that may be subject to interference of the third network device, to adjust a service of the third network device and avoid interference.

In some embodiments, the method according to the second aspect may further include: The first network device sends beam position offset information to a third network device when an area covered by a beam of a second network device overlaps the first beam position. The third network device and the second network device are a same device, or the third network device is configured to schedule the second network device, and the beam position offset information indicates an offset between the first beam position and an anchor beam position. It may be understood that beam position information of the anchor beam position may be preconfigured in the third network device. Therefore, even if the first network device sends only the beam position offset information to the third network device, the third network device can uniquely determine that a beam position indicated by the first beam position information is a beam position that may be subject to interference of the second network device, to adjust a service of the third network device and avoid interference.

In some embodiments, the method according to the second aspect may further include:

The first network device sends anchor beam position information to the third network device. The anchor beam position information includes M-level information indicating the anchor beam position, j^{th}-level information in the M-level information of the anchor beam position indicates a j^{th}-level area, (j+1)^{th}-level information in the M-level information of the anchor beam position indicates a (j+1)^{th}-level area, j is any integer from 1 to M-1, the j^{th}-level area includes the (j+1)^{th}-level area, and the (j+1)^{th}-level area includes the anchor beam position. It may be understood that whether the first network device sends second beam position information usually depends on whether the second beam position information is preconfigured in the third network device, so that sending of redundant information can be avoided.

In some embodiments, the method according to the second aspect may further include: The first network device sends service time information to the third network device. The service time information is used to determine time in which the first network device provides a service for the first beam position, to ensure that the third network device can disable a service on time, and avoid interference. Alternatively, if the third network device learns of the service time information in advance, the first network device may not send the service time information, to reduce overheads.

In addition, for technical effect of the method according to the second aspect, refer to the technical effect of the method according to the first aspect. Details are not described herein again.

According to a third aspect, a communication apparatus is provided. The communication apparatus includes modules configured to perform the method according to the first aspect, for example, a transceiver module and a processing module. For example, the transceiver module is configured to indicate a transceiver function of the communication apparatus, and the processing module is configured to perform a function of the communication apparatus other than the transceiver function.

In some embodiments, the transceiver module may include a sending module and a receiving module. The sending module is configured to implement a sending function of the communication apparatus according to the third aspect, and the receiving module is configured to implement a receiving function of the communication apparatus according to the third aspect.

In some embodiments, the communication apparatus according to the third aspect may further include a storage module. The storage module stores a program or instructions. When the processing module executes the program or the instructions, the communication apparatus is enabled to perform the method according to the first aspect.

It may be understood that the communication apparatus according to the third aspect may be a terminal, for example, a remote device, or may be a chip (system) or another part or component that may be disposed in the terminal, or may be an apparatus including the terminal. This is not limited in this application.

In addition, for technical effect of the communication apparatus according to the third aspect, refer to the technical effect of the method according to the first aspect. Details are not described herein again.

According to a fourth aspect, a communication apparatus is provided. The communication apparatus includes modules configured to perform the method according to the second aspect, for example, a transceiver module and a processing module. For example, the transceiver module indicates a transceiver function of the communication apparatus, and the processing module is configured to perform a function of the communication apparatus other than the transceiver function.

In some embodiments, the transceiver module may include a sending module and a receiving module. The sending module is configured to implement a sending function of the communication apparatus according to the fourth aspect, and the receiving module is configured to implement a receiving function of the communication apparatus according to the fourth aspect.

In some embodiments, the communication apparatus according to the fourth aspect may further include a storage module. The storage module stores a program or instructions. When the processing module executes the program or the instructions, the communication apparatus is enabled to perform the method according to the second aspect.

It may be understood that the communication apparatus according to the fourth aspect may be a terminal, for example, a remote device, or may be a chip (system) or another part or component that may be disposed in the terminal, or may be an apparatus including the terminal. This is not limited in this application.

In addition, for technical effect of the communication apparatus according to the fourth aspect, refer to the technical effect of the method according to the second aspect. Details are not described herein again.

According to a fifth aspect, a communication apparatus is provided. The communication apparatus includes a processor. The processor is configured to perform the method according to one or more embodiments of the first aspect or the second aspect.

In some embodiments, the communication apparatus according to the fifth aspect may further include a transceiver. The transceiver may be a transceiver circuit or an interface circuit. The transceiver may be used by the communication apparatus according to the fifth aspect to communicate with another communication apparatus.

In some embodiments, the communication apparatus according to the fifth aspect may further include a memory. The memory and the processor may be integrated together, or may be disposed separately. The memory may be configured to store a computer program and/or data related to the method according to the first aspect or the second aspect.

In embodiments of this application, the communication apparatus according to the fifth aspect may be the terminal according to the first aspect or the second aspect, or a chip (system) or another part or component that may be disposed in the terminal, or an apparatus including the terminal.

In addition, for technical effect of the communication apparatus according to the fifth aspect, refer to the technical effect of the method according to one or more embodiments of the first aspect or the second aspect. Details are not described herein again.

According to a sixth aspect, a communication apparatus is provided. The communication apparatus includes a processor. The processor is coupled to a memory, and the processor is configured to execute a computer program stored in the memory, so that the communication apparatus performs the method according to one or more embodiments of the first aspect or the second aspect.

In some embodiments, the communication apparatus according to the sixth aspect may further include a transceiver. The transceiver may be a transceiver circuit or an interface circuit. The transceiver may be used by the communication apparatus according to the sixth aspect to communicate with another communication apparatus.

In embodiments of this application, the communication apparatus according to the sixth aspect may be the terminal according to the first aspect or the second aspect, or a chip (system) or another part or component that may be disposed in the terminal, or an apparatus including the terminal.

In addition, for technical effect of the communication apparatus according to the sixth aspect, refer to the technical effect of the method according to one or more embodiments of the first aspect or the second aspect. Details are not described herein again.

According to a seventh aspect, a communication apparatus is provided, and includes a processor and a memory. The memory is configured to store a computer program, and when the processor executes the computer program, the communication apparatus performs the method according to one or more embodiments of the first aspect or the second aspect.

In some embodiments, the communication apparatus according to the seventh aspect may further include a transceiver. The transceiver may be a transceiver circuit or an interface circuit. The transceiver may be used by the communication apparatus according to the seventh aspect to communicate with another communication apparatus.

In embodiments of this application, the communication apparatus according to the seventh aspect may be the terminal according to the first aspect or the second aspect, or a chip (system) or another part or component that may be disposed in the terminal, or an apparatus including the terminal.

In addition, for technical effect of the communication apparatus according to the seventh aspect, refer to the technical effect of the method according to one or more embodiments of the first aspect or the second aspect. Details are not described herein again.

According to an eighth aspect, a communication system is provided. The communication system includes a terminal and a network device. The terminal is configured to perform the method according to one or more embodiments of the first aspect, and the network device is configured to perform the method according to one or more embodiments of the second aspect.

According to a ninth aspect, a computer-readable storage medium is provided, and includes a computer program or instructions. When the computer program or the instructions are run on a computer, the computer is enabled to perform the method according to one or more embodiments of the first aspect or the second aspect.

According to a tenth aspect, a computer program product is provided, and includes a computer program or instructions. When the computer program or the instructions are run on a computer, the computer is enabled to perform the method according to one or more embodiments of the first aspect or the second aspect.

### BRIEF DESCRIPTION OF DRAWINGS

FIG. 1 is a diagram of a network application architecture of low earth orbit satellite communication according to an embodiment of this application;

FIG. 2 is a diagram 1 of division into beam positions according to an embodiment of this application;

FIG. 3 is a diagram of beam position addressing according to an embodiment of this application;

FIG. 4 is a diagram of an architecture of a communication system according to an

embodiment of this application;

FIG. 5 is a schematic flowchart of a communication method according to an embodiment of this application;

FIG. 6 is a diagram 2 of division into beam positions according to an embodiment of this application;

FIG. 7 is a diagram 1 in which a terminal receives first beam position information according to an embodiment of this application;

FIG. 8 is a diagram 2 in which a terminal receives first beam position information according to an embodiment of this application;

FIG. 9 is a diagram in which an area covered by a beam of a second network device overlaps a first beam position according to an embodiment of this application;

FIG. 10 is a diagram of duplicate area addressing according to an embodiment of this application;

FIG. 11 is a diagram 1 of a structure of a communication apparatus according to an embodiment of this application; and

FIG. 12 is a diagram 2 of a structure of a communication apparatus according to an embodiment of this application.

### DESCRIPTION OF EMBODIMENTS

For ease of understanding, the following first describes technical terms in embodiments of this application.

A communication satellite is an artificial earth satellite used as a radio communication relay station. Communication satellites may be classified into a low earth orbit satellite, a medium earth orbit (MEO) satellite, and a high orbit synchronous communication satellite based on different running orbits of the communication satellites. The low earth orbit satellite is a satellite whose running orbit is between 500 kilometers (KM) to 2,000 km above the ground, is mainly used for mobile communication, and may provide global communication for a mobile terminal like a satellite phone, a vehicle-mounted terminal, a ship-borne terminal, or an airplane at any time and place.

FIG. 1 is a network application architecture of low earth orbit satellite communication. As shown in FIG. 1, the network application architecture mainly includes a terminal, an access network (AN), and a core network (CN).

The terminal may be a terminal having a transceiver function, or may be a chip or a chip system that may be disposed in the terminal. The terminal may also be referred to as user equipment (UE), an access terminal, a subscriber unit, a subscriber station, a mobile station (MS), a remote station, a remote terminal, a mobile device, a user terminal, a terminal, a wireless communication device, a user agent, or a user apparatus. The terminal in embodiments of this application may be a mobile phone, a cellular phone, a smartphone, a tablet computer (e.g., Pad), a wireless data card, a personal digital assistant (PDA) computer, a wireless modem (modem), a handheld device (e.g., handset), a laptop computer, a machine-type communication (MTC) terminal, a computer having a wireless transceiver function, a virtual reality (VR) terminal, an augmented reality (AR) terminal, a wireless terminal in industrial control, a wireless terminal in self-driving, a wireless terminal in telemedicine (e.g., remote medical), a wireless terminal in a smart grid, a wireless terminal in transportation safety, a wireless terminal in a smart city, a wireless terminal in a smart home, a vehicle-mounted terminal, an uncrewed aerial vehicle, a road side unit (RSU) having a terminal function, or the like. Alternatively, the terminal in this application may be a vehicle-mounted module, a vehicle-mounted assembly, a vehicle-mounted component, a vehicle-mounted chip, or a vehicle-mounted unit that is built in a vehicle as one or more components or units.

The AN is for implementing an access-related function, may provide a network access function for an authorized user in a specific area, and can determine transmission links with different quality based on a user level, a service requirement, and the like, to perform transmission of user data. The AN forwards a control signal and the user data between the terminal and the CN. The AN may include an access network device, or may be referred to as a radio access network (RAN) device.

The RAN device may be a device that provides access for the terminal. For example, the RAN device may include a satellite, for example, a low earth orbit satellite, or a gNB in 5G, for example, a new radio (NR) system, or one or a group of antenna panels (including a plurality of antenna panels) of a base station in 5G, or may be a network node that forms a gNB, a transmission point (TP), a transmission and reception point (TRP), or a transmission measurement function (TMF), for example, a baseband unit (e.g., a building baseband unit, BBU), a central unit (CU) or a distributed unit (DU), an RSU having a base station function, a wired access gateway, or a 5G core network element. Alternatively, the RAN device may further include an access point (AP) in a wireless fidelity (Wi-Fi) system, a wireless relay node, a wireless backhaul node, various forms of macro base stations, a micro base station (also referred to as a small cell), a relay station, an access point, a wearable device, a vehicle-mounted device, or the like. Alternatively, the RAN device may include an access network device in a next-generation mobile communication system like 6G, for example, a 6G base station. Alternatively, in a next-generation mobile communication system, the network device may be named in another manner, which falls within the protection scope of embodiments of this application. This is not limited in this application.

If the RAN device is deployed on an orbit in a form of a satellite, the AN may further include a ground station. The ground station is mainly configured to forward signaling and service data between the RAN device and the CN. Certainly, the RAN device on the orbit may alternatively directly interact with the CN. In this case, the ground station may not need to be deployed.

The CN is mainly responsible for maintaining subscription data of a mobile network, and provides session management, mobility management, policy management, security authentication, and another function for the terminal. The CN mainly includes the following network elements: a user plane function (UPF) network element, an access and mobility management function (AMF) network element, a session management function (SMF) network element, and the like.

The UPF network element is mainly responsible for user data processing (e.g., forwarding, receiving, charging, and the like). For example, the UPF network element may receive user data from a data network (DN), and forward the user data to the terminal via the access network device. The UPF network element may alternatively receive the user data from the terminal via the access network device, and forward the user data to the DN. The DN network element is an operator network that provides a data transmission service for a user, for example, an internet protocol multi-media service (IMS), and an internet. The DN may be an external network of an operator, or may be a network controlled by an operator, and is configured to provide a service for the terminal device.

The AMF network element is mainly for mobility management in the mobile network, for example, user position update, registration of a user to a network, and user handover.

The SMF network element is mainly for session management in the mobile network, for example, session establishment, modification, and release. A specific function is, for example, allocating an internet protocol (IP) address to a user, or selecting a UPF that provides a packet forwarding function.

In the foregoing network application architecture, the terminal and the RAN device usually interact with each other over an air interface, the network elements inside the AN usually interact with each other through an NG interface, the AN and the CN usually interact with each other through an Xn interface, and the network elements inside the CN usually interact with each other through an NG interface. For details, refer to the related descriptions in TS 38.401. Details are not described herein again.

In embodiments of this application, the RAN device is mainly deployed on an orbit in a form of a satellite, for example, a low earth orbit satellite. In this case, an area in which the low earth orbit satellite provides a service is an area irradiated by a beam of the low earth orbit satellite, and may be specifically an area that is on the ground and that is covered by a beam sent by a transmit antenna of the low earth orbit satellite at a specific pointing angle, which is also referred to as a beam position. A size of the beam position may be determined based on factors such as a size and a capability of a phased array.

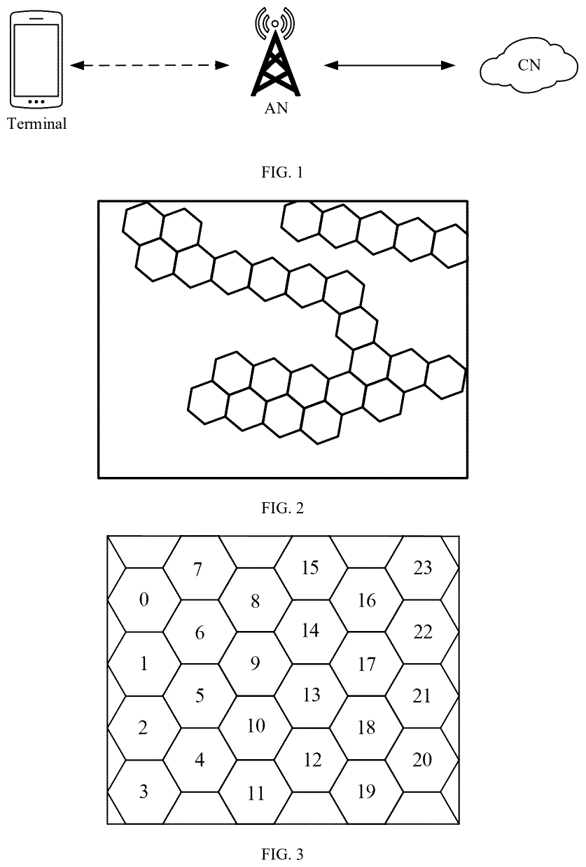

The low earth orbit satellite can implement global coverage in a constellation of a specific scale, that is, implement global coverage by using a large scale of beam positions. In this case, to ensure uniqueness of the beam position, each beam position needs to be divided, and each beam position is uniquely indicated through addressing. Sizes of the beam positions obtained through division into beam positions may be the same. As shown in FIG. 2, each hexagon in FIG. 2 is one beam position, and sizes of the beam positions are the same. Alternatively, sizes of the beam positions obtained through division into beam positions may be different. This is not specifically limited. Beam position addressing is to map, to a unique identifier (ID), each beam position obtained through division, to uniquely indicate the beam position by using the identifier of the beam position, so as to assist in subsequent beam position scheduling. Currently, a beam position addressing manner is to perform addressing by using a number or a letter. As shown in FIG. 3, each beam position is mapped to a unique number, and these numbers are numbers starting from 0 and increasing by 1 in sequence. In other words, a difference between identifiers of two adjacent beam positions may be 1. When global coverage is implemented by using the beam position, a quantity of beam positions exceeds 1 million. Therefore, 21 bits may be used to uniquely identify each beam position, to implement scheduling of each beam position.

However, currently, a beam position addressing manner is not determined. Therefore, how to address the beam position is a hot issue in current research.

To resolve the foregoing technical problem, embodiments of this application provide the following technical solutions, to ensure accuracy of beam position scheduling by accurately addressing each beam position.

The following describes the technical solutions of this application with reference to accompanying drawings.

The technical solutions in embodiments of this application may be applied to various communication systems, for example, a wireless network (e.g., Wi-Fi) system, a vehicle-to-everything (V2X) communication system, a device-to-device (D2D) communication system, an internet of vehicles communication system, a 4th generation (4G) mobile communication system, for example, a long term evolution (LTE) system, a worldwide interoperability for microwave access (WiMAX) communication system, 5th generation (5G), for example, a new radio (NR) system, and a future communication system.

All aspects, embodiments, or features are presented in this application by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In addition, in embodiments of this application, a term like “example” or “for example” indicates giving an example, an illustration, or a description. Any embodiment or implementation described as an “example” in this application should not be explained as being more preferred or having more advantages than another embodiment or implementation. Exactly, use of the term example is intended to present a concept in an exemplary manner.

In embodiments of this application, “information”, “signal”, “message”, “channel”, and “signaling” may be interchangeably used sometimes. It should be noted that meanings expressed by the terms are consistent when differences between the terms are not emphasized. Terms “of”, “corresponding, relevant”, and “corresponding” may be interchangeably used sometimes. It should be noted that meanings expressed by the terms are consistent when differences of the terms are not emphasized. In addition, a character “/” mentioned in this application may indicate an “or” relationship.

A network architecture and a service scenario described in embodiments of this application are intended to describe the technical solutions in embodiments of this application more clearly, and do not constitute a limitation on the technical solutions provided in embodiments of this application. A person of ordinary skill in the art may learn that, with evolution of the network architecture and emergence of new service scenarios, the technical solutions provided in embodiments of this application are also applicable to similar technical problems.

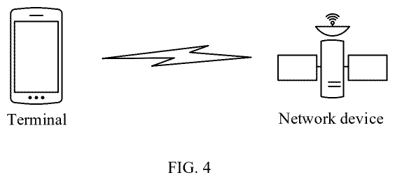

For ease of understanding embodiments of this application, a communication system shown in FIG. 4 is first used as an example to describe in detail a communication system applicable to embodiments of this application. For example, FIG. 4 is a diagram of an architecture of a communication system applicable to a communication method according to an embodiment of this application.

As shown in FIG. 4, the communication system mainly includes a terminal and a network device.

The terminal may be the terminal in the foregoing network application architecture. For details, refer to the foregoing related descriptions. Details are not described herein again. There may be one or more network devices, for example, a first network device, a second network device, and a third network device. Alternatively, the network device may be the network device in the foregoing network application architecture, for example, the RAN device. For details, refer to the foregoing related descriptions. Details are not described herein again.

In the communication system, the terminal and the network device may address a beam position through area level division. For example, beam position information may include N-level information in M-level information indicating a beam position, i^{th}-level information in the M-level information indicates an i^{th}-level area, (i+1)^{th}-level information in the M-level information indicates an (i+1)^{th}-level area, M is an integer greater than 1, N is an integer less than or equal to M, i is any integer from 1 to M-1, the i^{th}-level area includes the (i+1)^{th}-level area, and the (i+1)^{th}-level area includes the beam position. In this way, each beam position may be uniquely indicated based on beam position information corresponding to the beam position, to address the beam position.

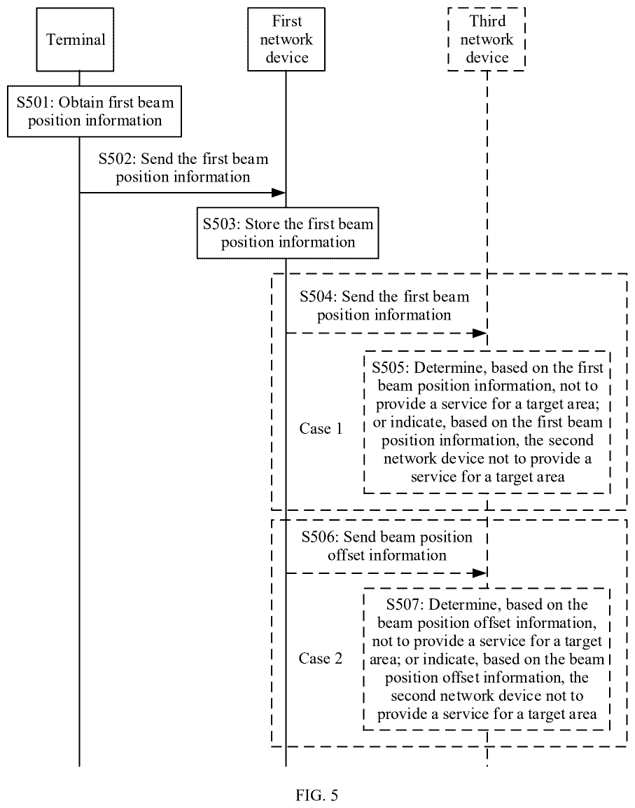

For ease of understanding, the following describes the communication method provided in this embodiment of this application with reference to FIG. 5.

For example, FIG. 5 is a schematic flowchart of a communication method according to an embodiment of this application. The method is applicable to communication between the terminal and the first network device in the foregoing communication system.

As shown in FIG. 5, a procedure of the foregoing communication method is as follows: S501: The terminal obtains first beam position information.

The first beam position information includes N-level information in M-level information indicating a first beam position.

The first beam position includes a beam position in which the terminal is located or a beam position to which the terminal is capable of moving. The beam position in which the terminal is located may be a beam position to which the terminal moves. The beam position to which the terminal is capable of moving may include a beam position directly adjacent or indirectly adjacent to the terminal.

i^{th}-level information in the M-level information may indicate at least one i^{th}-level area, and (i+1)^{th}-level information in the M-level information may indicate at least one (i+1)^{th}-level area. In addition, the M-level information corresponds to M-level areas, where M is an integer greater than 1, and i is any integer from 1 to M-1.

The M-level areas may be obtained in a plurality of division manners. A typical manner is to perform division based on a fixed area size. For example, division is performed based on longitude and latitude, so that areas at a same level that include any two of a plurality of beam positions have a same size. Another typical manner is to perform division based on a non-fixed area size. For example, division is performed based on a country or a coastline, so that areas at a same level that include any two of a plurality of beam positions have different sizes. Details are described below.

Manner 1: Division is performed based on the fixed area size.

A to-be-divided area may be first equally divided into a plurality of first-level areas,

and then each first-level area is equally divided into a plurality of second-level areas. Division is performed according to this rule until each (M-1)^{th}-level area is equally divided into a plurality of M^{th}-level areas. A quantity of areas obtained through division at each level is the same.

Manner 2: Division is performed based on the non-fixed area size.

A to-be-divided area may be first divided into a plurality of first-level areas based on an actual situation, for example, divided based on a country, and then, each first-level area is divided into a plurality of second-level areas based on an actual situation, for example, divided based on a city. Division is performed according to this rule until each (M-1)^{th}-level area is divided into a plurality of M^{th}-level areas.

It can be learned that, after the M-level areas are obtained through division, the i^{th}-level area includes the (i+1)^{th}-level area, and an area size of the i^{th}-level area is greater than an area size of the (i+1)^{th}-level. It may be understood that each M^{th}-level area in the foregoing two manners may include one beam position, and the M^{th}-level area can indicate one unique beam position. In other words, a size of the M^{th}-level area may be the same as a preset size of a beam position before the M-level areas are obtained through division.

The N-level information is at least a part of the M-level information. For example, the N-level information may include M^{th}-level information, (M-1)^{th}-level information, . . . , and K^{th}-level information, where K is equal to M-N+1. For another example, the N-level information may include first-level information, second-level information, . . . , and N^{th}-level information, where N is an integer less than or equal to M.

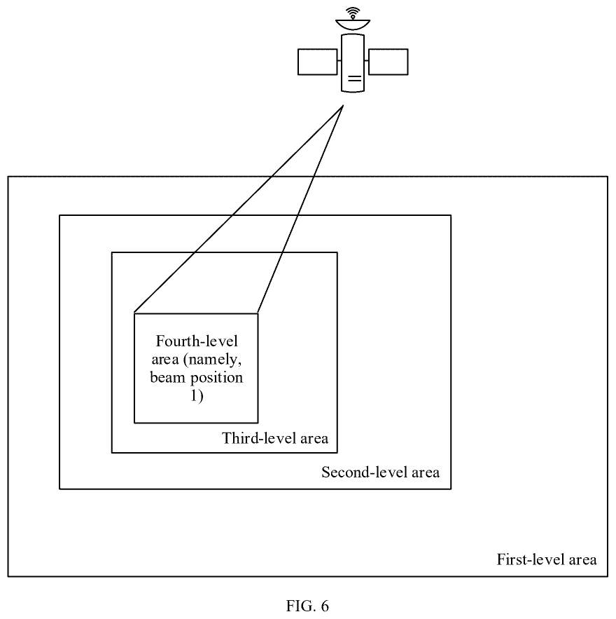

For example, as shown in FIG. 6, the first beam position is a beam position 1, and M is 4. The M-level information includes first-level information, second-level information, third-level information, and fourth-level information. The first-level information, the second-level information, the third-level information, and the fourth-level information respectively correspond to a first-level area, a second-level area, a third-level area, and a fourth-level area. The first-level area includes the second-level area, the second-level area includes the third-level area, and the third-level area includes the fourth-level area. In addition, the fourth-level area includes the beam position 1. When N is 2, the N-level information may include the third-level information and the fourth-level information.

It can be learned that the first beam position is included in an (i+1)^{th}-level area, and the (i+1)^{th}-level area is included in an i^{th}-level area. In other words, the N-level information indicates information of the first beam position in each of different levels of sequentially included areas. The first beam position is indicated based on information of a plurality of areas having an inclusion relationship, so that the beam position can be accurately indicated based on the first beam position information.

It may be understood that, in this embodiment of this application, that the i^{th}-level area includes the (i+1)^{th}-level area means that area sizes are sorted in descending order. However, in practice, the area sizes may alternatively be sorted in ascending order. For example, in the M-level areas, the (i+1)^{th}-level area includes the i^{th}-level area. This is not limited.

In this embodiment of this application, the first beam position information is obtained in a plurality of manners, for example, obtained locally or from another device. The following separately provides descriptions.

In some embodiments, the terminal may receive the first beam position information broadcast by the first network device.

The first network device may periodically broadcast the first beam position information to a beam position. When the terminal is located in the beam position, the terminal may receive the first beam position information. In some embodiments, when the first beam position information indicates the beam position, the terminal may receive beam position information of the beam position in which the terminal is located. When the first beam position information indicates a beam position adjacent to the beam position, the terminal may receive beam position information of the beam position to which the terminal is capable of moving.

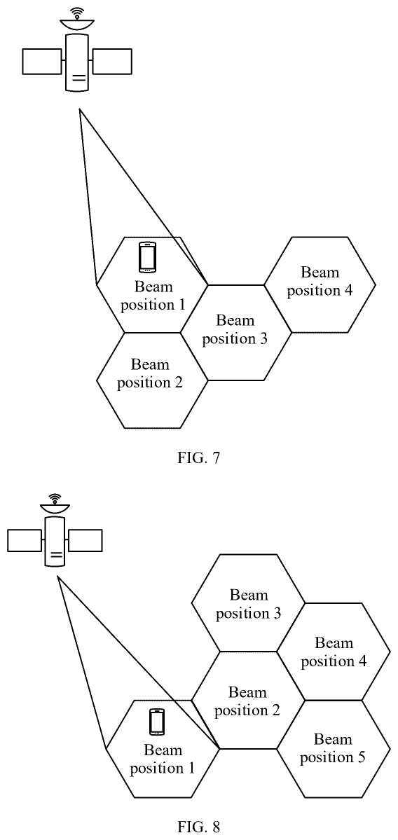

For example, as shown in FIG. 7, the first network device periodically broadcasts beam position information of a beam position 1 to the beam position 1, and the terminal is located in the beam position 1. In this case, the terminal may receive the beam position information of the beam position 1, namely, information of the beam position in which the terminal is located.

For another example, as shown in FIG. 8, a beam position 1 to a beam position 5 are included in the figure, the beam position 1 is adjacent to the beam position 2, the beam position 2 is adjacent to the beam position 3, the beam position 4, and the beam position 5, and the terminal is located in the beam position 1. When the first network device periodically broadcasts beam position information of the beam position 2 to the beam position 1, the terminal may receive the beam position information of the beam position 2, namely, beam position information of a beam position to which the terminal is capable of moving.

In some embodiments, the terminal may receive area information from the first network device, to determine the first beam position information based on the area information and a position of the terminal and according to a preset rule.

The area information may be used to determine an area covered by a beam of the first network device, namely, an area that can be served by the first network device. In addition, the area information may be vertex coordinates and shape information of the area, or coordinates of each vertex of the area. The preset rule indicates that beam positions in the area covered by the beam of the first network device are obtained through division based on the M-level areas. The preset rule is preconfigured in the terminal, that is, the terminal knows that the beam positions are obtained through division based on the M-level areas. In this way, the terminal may determine, based on the area information and according to the preset rule, division into beam positions of the area covered by the beam of the first network device. In other words, the terminal may know beam positions in the area covered by the beam of the first network device, and beam position information indicating these beam positions. In this way, the terminal may determine, based on the position of the terminal, a beam position in which the terminal is located or a beam position to which the terminal is capable of moving, to determine the first beam position information corresponding to the beam position.

For example, the first network device serves an area A, area information of the area A includes vertex coordinates (a, b) of the area A and information of a rectangular area whose length is 2 km and width is 1 km, and a preset rule is to divide the area into three-level areas. In some embodiments, the to-be-divided area is first equally divided into 10 first-level areas, then each first-level area is equally divided into five second-level areas, and then each second-level area is equally divided into three third-level areas. In addition, consecutive numbers are mapped to the areas at each level in a division sequence. The terminal may first calculate a position of the area A on the ground based on the vertex coordinates and the information of the rectangular area whose length is 2 km and width is 1 km. Then, a position and beam position information of each beam position in the area A are determined with reference to the division rule of three-level areas. In this way, the terminal may determine the first beam position based on the position information of the terminal, to determine the first beam position information.

For another example, the first network device serves an area B, and area information of the area B includes coordinates of each vertex of the area B. The terminal may first determine a position of the area B on the ground based on the coordinates of the vertex, and then determine, in the area A, distribution of each beam position and beam position information corresponding to the beam position with reference to a preset division rule of five-level areas. In this way, the terminal may determine the first beam position based on the position information of the terminal, to determine the first beam position information.

It may be understood that the preset rule may be not limited to a manner in which M-level areas are obtained through division. For example, if a direct addressing manner is used for an area, the preset rule may be a rule of direct addressing. For example, an addressing manner pre-stored on the terminal may be sequentially mapping, to beam positions in a left-to-right and top-to-bottom sequence, consecutive numbers starting from 0.

It may be further understood that, when the area information is other information that can indicate the area covered by the beam of the first network device, the terminal may also first determine a position of the area on the ground based on the area information, and then determine the first beam position information sequentially with reference to the preset rule and the position of the terminal.

In some embodiments, the terminal may receive beam position set information from the first network device, and determine the first beam position information based on position distribution of a plurality of beam positions and the position of the terminal.

The beam position set information indicates the position distribution of the plurality of beam positions, that is, the beam position set information may include positions of the plurality of beam positions on the ground and beam position information corresponding to the beam positions. The first beam position is included in the plurality of beam positions. In addition, the plurality of beam positions may be all beam positions in a range covered by the beam of the first network device. The position may be central coordinates of the beam position and a length from the central coordinates to a vertex of the beam position, or may be other information that can indicate the position of the beam position on the ground. In this way, the terminal may determine, based on the position of the terminal, a beam position in which the terminal is located or a beam position that is in the plurality of beam positions and to which the terminal is capable of moving, to determine the first beam position information.

For example, the beam position set information includes position information and beam position information of a beam position 1, a beam position 2, and a beam position 3, the position information of the beam position 1, the beam position 2, and the beam position 3 is respectively a, b, and c, the beam position 1 is adjacent to the beam position 2, and the terminal is located in a. When receiving the beam position set information, the terminal may determine, with reference to information indicating that the terminal is located in a, that the terminal is located in the beam position 1, and determine first beam position information, namely, the beam position information of the beam position 1. Alternatively, the terminal may determine, with reference to the information indicating that the terminal is located in a, that a beam position to which the terminal is capable of moving is the beam position 2, and determine the first beam position information, namely, the beam position information of the beam position 2.

In some embodiments, the terminal may pre-store addressing information of all beam positions in a smart card (e.g., a subscriber identification module (SIM) card).

The addressing information of all beam positions may include positions of all the beam positions on the ground and beam position information of the beam positions, or may include positions of all beam positions in the area covered by the beam of the first network device and beam position information of the beam positions. In this way, the terminal may determine, based on the position of the terminal, a beam position that is in the addressing information of all beam positions and that corresponds to the position of the terminal or a beam position that is in the addressing information of all beam positions and that corresponds to a position to which the terminal is capable of moving, to determine beam position information of the beam position, namely, the first beam position information.

After obtaining the first beam position information, the terminal may continue to perform S502.

S502: The terminal sends the first beam position information to the first network device. The first network device receives the first beam position information from the terminal.

The area covered by the beam of the first network device includes the first beam position. In other words, the first network device may provide a service for the terminal.

In this embodiment of this application, the terminal may send the first beam position information in a plurality of cases. For example, the terminal may send the first beam position information after the position changes, or send the first beam position information when a service is required. The following separately provides descriptions.

In some embodiments, the terminal may send the first beam position information to the first network device when the terminal determines that the terminal moves to the first beam position.

In some embodiments, after the beam position of the terminal changes, the terminal may upload current beam position information of the terminal to the first network device in time. For example, after the terminal moves from a beam position A to a beam position B, the terminal may send beam position information of the beam position B to the first network device, so that the first network device can perform scheduling in time, to avoid a scheduling error.

In some embodiments, the terminal may send the first beam position information to the first network device when the terminal determines that the terminal is capable of moving to the first beam position.

The first beam position may be the beam position directly adjacent or indirectly adjacent to the terminal. The terminal sends the beam position information of the first beam position to the first network device, so that the first network device can prepare for handover of the terminal in advance, thereby ensuring timeliness of the handover.

For example, if the beam position in which the terminal is located is a beam position A, and a beam position adjacent to the beam position A is a beam position B, the beam position B may be the first beam position. Correspondingly, the terminal may send beam position information of the beam position B to the first network device. For another example, if the beam position in which the terminal is located is a beam position a, a beam position adjacent to the beam position a is a beam position b, and a beam position adjacent to the beam position b is a beam position c, the beam position c may be the first beam position. Correspondingly, the terminal may send beam position information of the beam position c to the first network device.

In some embodiments, the terminal may send the first beam position information to the first network device when the terminal determines that the terminal needs to obtain a service of the first network device, to ensure that the first network device can provide the service for the terminal in time.

For example, when the terminal needs to perform network communication with another terminal, the terminal may send the first beam position information to the first network device. For another example, when the terminal needs to view a network video, the terminal may send the first beam position information to the first network device.

It may be understood that the terminal may further periodically send the first beam position information to the first network device. For example, the terminal may send the first beam position information to the first network device every 3 s.

After receiving the first beam position information, the first network device may continue to perform S503.

S503: The first network device stores the first beam position information.

The first network device may cache the first beam position information in a memory, to implement dynamic storage. Alternatively, the first network device may store the first beam position information in a hard disk drive, to avoid an information loss. Alternatively, the first network device may store the first beam position information in any possible form. This is not limited.

After storing the first beam position information, the first network device may obtain the first beam position in time when subsequently providing a service for the terminal, to provide the service for the terminal in time. In addition, because the first beam position information is level information, and the level information can indicate a unique beam position, the first network device can accurately determine the first beam position based on the first beam position information, to ensure that the first network device can accurately perform scheduling subsequently based on the first beam position.

In conclusion, after obtaining the first beam position information, the terminal may send the first beam position information to the first network device. Because the first beam position information is the level information, the first network device can determine the unique beam position based on the level information, to accurately address each beam position, and ensure that the first network device can accurately perform scheduling based on the first beam position.

In some embodiments, with reference to S501 to S503, operations for interference scheduling may be further performed in the method provided in this embodiment of this application.

For example, the first network device may perform interference scheduling when an area covered by a beam of a second network device overlaps the first beam position. That the area covered by the beam of the second network device overlaps the first beam position indicates that the beam of the second network device may affect service providing of the first network device for the terminal. In other words, when the first network device provides a service for the first beam position, if the beam of the second network device is enabled and irradiates a part of an area of the first beam position, the beam of the first network device is interfered, and consequently, service providing of the first network device for the terminal is affected.

The case in which the beam of the second network device interferes with the beam position indicated by the first beam position information may be dealt with in a plurality of manners. For example, the first network device may send the first beam position information to a third network device, so that the third network device makes, based on the first beam position information, the second network device disable the beam that affects the beam position. Alternatively, the first network device may send beam position offset information to the third network device, so that the third network device makes, based on the beam position offset information, the second network device disable the beam that affects the beam position. The following provides descriptions with reference to example cases.

### Case 1:

S504: The first network device sends the first beam position information to the third network device. The third network device receives the first beam position information from the first network device.

The first beam position information may be complete level information. In other words, the N-level information included in the first beam position information is the M-level information, that is, Nis equal to M. For an exemplary implementation principle, refer to the related descriptions in S501. Details are not described herein again. The position information and the beam position information of all the beam positions in the area covered by the beam of the first network device are preconfigured in the third network device, and the position information includes positions of the beam positions on the ground.

When N is equal to M, and the area covered by the beam of the second network device overlaps the first beam position, because the beam of the second network device may affect service providing of the first network device for the terminal, the first network device may send the first beam position information to the third network device (that is, perform S504). In this way, the third network device determines, based on the first beam position information, the beam position on which interference scheduling is to be performed, and performs interference scheduling on the second network device based on the beam position, that is, makes the second network device disable the beam that can irradiate the beam position.

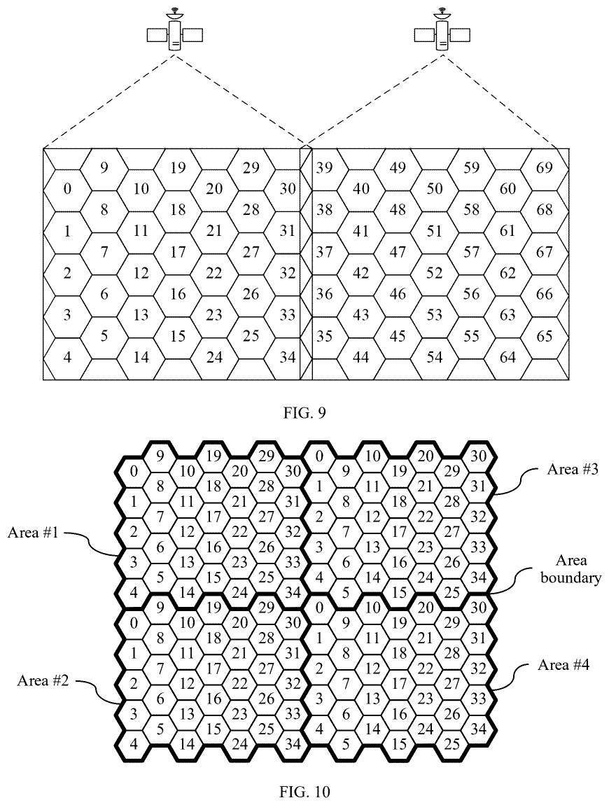

For example, as shown in FIG. 9, a satellite in the upper left of the figure is the first network device, and the first network device provides services for beam positions 0 to 34; a satellite in the upper right of the figure is the second network device, and the second network device provides services for beam positions 35 to 69; and the first beam position is the beam position 33. It can be learned from FIG. 9 that an area covered by a beam of the second network device further includes a part of areas of the beam positions 30 to 34. Therefore, when the first network device provides a service for the beam position 33, the beam of the second network device may irradiate a part of the area of the beam position 33, and consequently, cause interference to the service provided by the first network device. In this case, the first network device may send beam position information, namely, the first beam position information, of the beam position 33 to the third network device, so that the third network device performs interference scheduling on the second network device based on the beam position 33.

It may be understood that the first network device may determine, based on a preconfigured beam coverage range of the second network device, whether a part of the area of the first beam position is covered by the beam of the second network device. In addition, when determining that a part of the area of the beam position is covered by the beam of the second network device, the first network device sends the first beam position information to the third network device. Alternatively, the first network device may first determine whether the first beam position is located in an edge area of the area covered by the beam of the first network device, for example, whether the first beam position is located in beam positions 0 to 4 and 30 to 34 in FIG. 9. If the first beam position is located in the edge area, it indicates that a part of the area of the beam position may be covered by the beam of the second network device. In this case, the first network device may further determine whether a part of the area of the beam position is covered by the beam of the second network device. When determining that a part of the area of the beam position is covered by the beam of the second network device, the first network device sends the first beam position information to the third network device.

In some embodiments, the first network device may further send position information of the first network device to the third network device. The third network device receives the position information from the first network device.

The position information may be absolute position information of the first network device relative to the ground, for example, ephemeris information, or may be relative position information of the first network device and the third network device. For example, when the third network device and the second network device are a same device, the position information may be “left”, indicating that the satellite in which the first network device is located is on the left of the satellite in which the third network device is located. In this case, the third network device may determine, based on pre-stored constellation information and “left”, the ephemeris information of the satellite in which the first network device is located, and determine, based on the position information, the area covered by the beam of the first network device. It may be understood that the position information of the first network device is position information of the first network device when the first network device receives the first beam position information.

For example, the first network device may further send the position information of the first network device to the third network device when the first beam position information indicates that there are a plurality of first beam positions. A case in which the first beam position information indicates that there are a plurality of first beam positions indicates that a plurality of different beam positions may be found and determined based on the first beam position information, that is, M-level information of the plurality of beam positions is the same.

It may be understood that, in a phase of addressing an area, if repeated addressing is performed on a plurality of partial areas of the area, that is, the partial areas reuse a same set of addressing content, the M-level information of the plurality of beam positions may be the same. In other words, when beam position addressing is performed on an area, a partial area may be first addressed, and addressing content of the partial area is reused to a remaining area.

In some embodiments, in a phase of repeatedly addressing areas, a to-be-addressed area may be first divided into a plurality of same partial areas, and then any partial area is addressed, for example, an M-level area is addressed. After the partial area is addressed, addressing content of the partial area may be reused to another partial area. Alternatively, a partial area may be first determined in the to-be-addressed area, and the partial area is addressed. After the partial area is addressed, the partial area is translated on the to-be-addressed area, so that addressing content of the partial area is reused to a remaining area of the to-be-addressed area.

For example, as shown in FIG. 10, an entire area includes four partial areas: an area #1, an area #2, an area #3, and an area #4. After the area #1 is addressed, an addressing result of the area #1 may be reused to the area #2, the area #3, and the area #4, to complete addressing of the entire area.

It may be understood that a size of the partial areas is less than or equal to a maximum coverage area of the beam of the satellite, and the size of the partial areas can ensure that when the satellite moves to any position, beam position information of each beam position is unique in the area covered by the beam of the satellite. Because the size of the partial areas is less than or equal to that of the entire area, addressing is performed on the partial areas, so that signaling overheads can be reduced. For example, if an addressing set for directly addressing the entire area is s₁={0, 1, 2, . . . , 10N}, signaling overheads are log2(10N). If an addressing set for directly addressing the partial areas is s₂={0, 1, 2, . . . , N}, signaling overheads for using a repeated addressing mechanism are log₂(N).

When the first network device can determine the plurality of beam positions based on the first beam position information, the first network device sends the position information of the first network device to the third network device, so that the third network device can determine, based on the position information, the area covered by the beam of the first network device. In addition, because the beam position information of each beam position is unique in the area covered by the beam of the first network device, the third network device may determine the first beam position with reference to the area covered by the beam of the first network device and the first beam position information.

For another example, the first beam position information may be incomplete level information, that is, the N-level information included in the first beam position information is not the M-level information, that is, N is less than M. For an exemplary implementation principle, refer to the related descriptions in S501. Details are not described herein again. In this case, a rule of dividing the M-level areas is preset in the third network device.

When N is less than M, and the area covered by the beam of the second network device overlaps the first beam position, because the first beam position information is the incomplete level information, a plurality of pieces of M-level information may be determined based on the first beam position information. In addition, because the beam position information of each beam position in the area covered by the beam of the first network device is usually unique, the first network device may send the first beam position information and the position information of the first network device to the third network device, so that the third network device can determine unique beam position information based on the first beam position information and the position information, that is, determine the first beam position, and perform interference scheduling on the second network device based on the first beam position. In addition, when N is less than M, transmission overheads of the N-level information are lower than transmission overheads of the M-level information. Therefore, sending the first beam position information and the position information of the first network device to the third network device by the first network device can further reduce the transmission overheads.

For example, the first beam position information is third-level information in three-level information, namely, 10, and the position information is information of an area #11. The third network device may determine two pieces of beam position information based on the first beam position information, which are 101310 and 141510 respectively, determine, based on the information of the area #11, that beam position information in the area #11 includes 101307, 101309, and 101310, and therefore, determine that 101310 is complete beam position information corresponding to the first beam position information, and determine the first beam position based on 101310.

In some embodiments, the first network device may further send service time information to the third network device. The third network device receives the service time information from the first network device.

The service time information is used to determine time in which the first network device provides a service for the first beam position. In this way, the third network device can make, based on the service time information, the second network device disable, in a time period in which the first network device provides the service for the first beam position, a beam that affects the beam position, and use of the beam after the time period is not affected. For example, if the first network device further sends [14:00, 14:30] to the third network device, it indicates that the first network device serves the beam position corresponding to the first beam position information in the time period from 14:00 p.m. to 14:30 p.m.

After receiving the first beam position information from the terminal, the third network device may continue to perform S505.

S505: The third network device may determine, based on the first beam position information, not to provide a service for a target area; or the third network device may indicate, based on the first beam position information, the second network device not to provide a service for a target area.

The third network device and the second network device may be a same device, or may be different devices. Therefore, when receiving the first beam position information, the third network device may perform different operations based on a relationship between the third network device and the second network device. The following separately provides descriptions.

In some embodiments, the third network device and the second network device are the same device, and the third network device may determine, based on the first beam position information, not to provide the service for the target area.

The third network device may be a satellite. As shown in FIG. 9, the third network device may be the satellite in the upper right in FIG. 9. The target area is an area in which the area covered by the beam position of the second network device overlaps a beam position in at least one beam position. As shown in FIG. 9, the target area may be an area that can be covered by the beam of the second network device in the beam position 33. The beam position information of all the beam positions in the area covered by the beam of the first network device is preconfigured in the third network device.

In some embodiments, the third network device may determine the first beam position based on the first beam position information, then determine the target area based on the first beam position and the preset rule of dividing the M-level areas, and disable the beam that can cover the target area, to avoid a case in which the beam of the second network device affects service effect when the first network device provides the service for the terminal.

In some embodiments, the third network device may further determine, based on the first beam position information and the service time information, not to provide the service for the target area in the time in which the first network device provides the service for the beam position in the at least one beam position indicated by the first beam position information, to disable the beam on time, that is, disable the beam that affects the target area in the time, and subsequent use of the beam is not affected.

For example, if the first beam position information received by the third network device is ABBCCCDDDD, and the service time information is [11:00, 14:00], the third network device may disable, in a time period from 11:00 a.m. to 14:00 p.m., a beam that can irradiate a beam position whose beam position information is ABBCCCDDDD.

In some embodiments, the third network device may further determine, based on the first beam position information and the position information of the first network device, not to provide the service for the target area.

For example, when the first beam position information indicates that there are a plurality of first beam positions, and the first beam position information is complete beam position information, the third network device may determine, based on the position information of the first network device, the area covered by the beam of the first network device. Because the beam position information of each beam position is unique in the area covered by the beam of the first network device, the third network device may determine the target area with reference to the area covered by the beam of the first network device and the first beam position information.

For another example, when the first beam position information is incomplete level information, a rule may be preset in the third network device, for example, a rule of dividing the M-level areas. Correspondingly, the third network device may determine, based on the position information of the first network device, the area covered by the beam of the first network device, and then determine the beam position information of each beam position in the area based on the area and the rule of dividing the M-level areas. Because the beam position information of the beam position in the area is usually unique, the third network device may determine, based on the beam position information of each beam position in the area and the first beam position information, the beam position to be served by the first network device, namely, the first beam position, and disable the beam that covers the beam position, to avoid a case in which the beam of the second network device affects service effect when the first network device provides the service for the terminal.

In some embodiments, the third network device and the second network device are different devices, and the third network device is configured to schedule the second network device. The third network device may indicate, based on the first beam position information, the second network device not to provide the service for the target area.

The third network device may be a ground control unit or a base station, and the base station may be disposed on the ground or a satellite. The second network device may be a satellite. In other words, the third network device only makes a scheduling decision based on received information, and the second network device executes the scheduling decision.

It may be understood that there are two cases as to the relationship between the third network device and the second network device in the case 1. For example, when the third network device and the second network device are the same device, the third network device makes the scheduling decision, and executes a decision result. When the third network device and the second network device are different devices, the third network device is configured to schedule the second network device, that is, the third network device makes the scheduling decision, and sends the scheduling decision to the second network device, for the second network device to execute the scheduling decision. It can be learned that, when the third network device and the second network device are different devices, receiving and sending operations and processing operations performed by the third network device are the same as those performed by the third network device when the third network device and the second network device are the same device, and a difference lies in that the third network device may indicate the second network device to execute the corresponding decision result. Therefore, for the operations of the third network device, refer to the related descriptions of the receiving and sending operations and the processing operations performed by the third network device when the third network device and the second network device are the same device. Details are not described herein again.

It may be further understood that the foregoing embodiment is merely an example, and no limitation is imposed. For example, when the first network device needs to perform interference scheduling, the first network device may send, to the third network device, beam position information of a beam position on which interference scheduling needs to be performed. In addition, when there are a plurality of beam positions on which interference scheduling needs to be performed, the first network device may send beam position information of the plurality of beam positions to the third network device, to implement interference scheduling on the plurality of beam positions. For another example, to make the second network device disable, on time, a beam that generates interference, the first network device may further send, when sending, to the third network device, the beam position information of the beam position on which interference scheduling needs to be performed, service time information corresponding to the beam position; or when sending the beam position information of the plurality of beam positions to the third network device, the first network device may send a plurality of pieces of service time information corresponding to the plurality of beam positions.

### Case 2:

S506: The first network device sends the beam position offset information to the third network device. The third network device receives the beam position offset information from the first network device.

The beam position offset information indicates an offset between the first beam position and an anchor beam position, namely, an offset between the first beam position information and anchor beam position information. For example, the beam position offset information may be an offset between the first beam position information and each level of information corresponding to beam position information of the anchor beam position, or anchor beam position information. There may be a plurality of offsets. For example, the first beam position information is 010301, where first-level information is 0 second-level information is 03, and third-level information is 01. The anchor beam position information is 030203, where first-level information is 03, second-level information is 02, and third-level information is 03. It can be learned that offsets between the first beam position information and the first-level information, the second-level information, and the third-level information of the anchor beam position information are −2, 1, and −2 respectively. Therefore, the beam position offset information may be [−2, 1, −2]. Alternatively, the beam position offset information may be an overall offset between the first beam position information and M-level information of the anchor beam position information. For example, as shown in Table 1, Table 1 shows beam position information and indexes corresponding to the beam position information. The first beam position information is ABBCCC, and an index of the first beam position information in a preset table (e.g., Table 1) is 2. The anchor beam position information is ABBAAA, and an index of the anchor beam position information in the preset table (e.g., Table 1) is 0. Therefore, the beam position offset information may be an offset between the index of the first beam position information and the index of the anchor beam position information, namely, 2.

TABLE 1

| Index | Beam position information |
|---|---|
| 0 | ABBAAA |
| 1 | ABBBBB |
| 2 | ABBCCC |
| 3 | ABBDDD |
| . . . | . . . |

It may be understood that, when the preset table is used, any beam position information other than the first beam position information may be used as the anchor beam position information. Correspondingly, the beam position offset information is an offset between the index of the first beam position information and an index of the anchor beam position information. For example, as shown in Table 1, the first beam position information is ABBCCC, and the index of the first beam position information in the preset table (e.g., Table 1) is 2. The anchor beam position information is ABBDDD, and an index of the anchor beam position information in the preset table (e.g., Table 1) is 3. In this case, the beam position offset information may be an offset between the index of ABBCCC and the index of ABBDDD, namely, −1.

It may be further understood that the beam position offset information may be a value obtained by subtracting each level of information of the anchor beam position information from each level of information of the first beam position information, or a value obtained by subtracting the index of the anchor beam position information in the preset table from the index of the first beam position information in the preset table. Alternatively, the value may be a value obtained by subtracting each level of information of the first beam position information from each level of information of the anchor beam position information, or a value obtained by subtracting the index of the first beam position information in the preset table from the index of the anchor beam position information in the preset table. This is not limited.

When interference scheduling needs to be performed, the first network device may send, to the third network device, beam position offset information of a beam position to be served. For example, the first network device is to serve a beam position #22, and interference scheduling needs to be performed on the beam position #22. The first network device may send, to the third network device, the beam position offset information corresponding to the beam position #22. Alternatively, the first network device may periodically send, to the third network device, beam position information of a beam position on which interference scheduling needs to be performed in a current period. For example, the first network device sends, to the third network device every hour, a beam position offset of each beam position on which interference scheduling needs to be performed in the hour.

It may be understood that the first network device may send one piece of beam position offset information, or may send a plurality of pieces of offset information. When the plurality of pieces of offset information are sent, it indicates that interference scheduling needs to be performed on a plurality of beam positions.

The anchor beam position information includes M-level information indicating the anchor beam position, j^{th}-level information in the M-level information of the anchor beam position indicates a j^{th}-level area, (j+1)^{th}-level information in the M-level information of the anchor beam position indicates a (j+1)^{th}-level area, j is any integer from 1 to M-1, the j^{th}-level area includes the (j+1)^{th}-level area, and the (j+1) th-level area includes the anchor beam position. In other words, the anchor beam position information is the M-level information of the anchor beam position obtained through division based on M-level areas. For an exemplary implementation principle, refer to the related descriptions in S501. Details are not described herein again. The anchor beam position information is preconfigured in the third network device.

It may be understood that the anchor beam position information may be beam position information of a reference point, and the reference point is a standard point defined in the R17 protocol. The anchor beam position information is set as the beam position information of the reference point, so that the existing standard can be better integrated.

It may be further understood that the “anchor beam position” and the “anchor beam position information” mentioned in this embodiment of this application are merely an example expression, and the “anchor beam position” may alternatively be replaced with any possible expression, for example, a “reference beam position”, an “anchor beam position”, or a “preset beam position”; and the “anchor information beam position” may alternatively be replaced with any possible expression, for example, “reference beam position information”, “anchor beam position information”, or “preset beam position information”. This is not limited.

In some embodiments, when the area covered by the beam of the second network device overlaps the first beam position, the first network device may send the beam position offset information to the third network device, so that the third network device can determine the first beam position based on the beam position offset information and the anchor beam position information, to perform interference scheduling. In addition, because overheads for transmitting the beam position information are usually high, transmission overheads can be reduced by transmitting the beam position offset information.

For example, the beam position offset information sent by the first network device is [0, 0, 2], and the beam position offset information may be indicated through enumeration, that is, different padding values indicate different levels of beam position offset information. The anchor beam position information is 011316, where first-level information, second-level information, and third-level information of the anchor beam position information is 01, 13, and 16 respectively. It can be learned that offset values between the first beam position information and the first-level information, the second-level information, and the third-level information of the anchor beam position information are 0, 0, and 2 respectively. Therefore, based on the beam position offset information and the anchor beam position information, it may be determined that the first beam position information is 011318, that is, the first beam position is a beam position indicated by 011318.

For another example, the beam position offset information sent by the first network device is 3, and the beam position offset information may be a bitmap, that is, the offset of 3 is indicated by using a value of the bitmap. For example, the offset may be indicated by using 2 bits, and the offset is 11; or the offset may be indicated by using 3 bits, and the offset is 011; or the offset may be indicated by using 4 bits, and the offset is 0011. This is not limited. If the anchor beam position information is ABBAAA, the third network device may search Table 1 for beam position information that has an offset of 3 from the anchor beam position information, and may obtain that the beam position information ABBDDD, that is, the first beam position information is ABBDDD.

In some embodiments, the first network device may further send the anchor beam position information to the third network device. The third network device receives the anchor beam position information from the first network device. For example, the anchor beam position information is sent when the third network

device does not store the anchor beam position information, so that beam position information used as a reference by the two parties can be aligned. In some embodiments, the first network device may encapsulate the anchor beam position information and the beam position offset information into one message for sending, for example, separately carry the anchor beam position information and the beam position offset information by using different information elements of the message. In this case, because information elements in the message used to carry information are agreed on by the two parties in advance, after receiving the message, the third network device may obtain the anchor beam position information and the beam position offset information from the corresponding information elements. Alternatively, in some embodiments, the first network device may respectively encapsulate the anchor beam position information and the beam position offset information into different messages for sending. For example, the beam position offset information is encapsulated into a message #1, and the anchor beam position information is encapsulated into a message #2. Because information that can be sent by using the messages are agreed on by the two parties in advance, when receiving the message #1, the third network device knows that the message #1 is a message used to carry the beam position offset information, and can obtain the beam position offset information from the message #1. In addition, when receiving the message #2, the third network device knows that the message #2 is a message used to carry the anchor beam position information, and can obtain the anchor beam position information from the message #2.

Certainly, if the anchor beam position information is preconfigured in the third network device, the first network device may not send second beam position information to the third network device, to avoid communication redundancy.

It may be understood that the first network device may further send the beam position offset information and the anchor beam position information to the third network device when performing interference scheduling on both the first beam position and the anchor beam position, to avoid sending of two pieces of beam position information, so as to reduce transmission overheads.

To make the second network device disable, on time during interference scheduling, the beam that causes interference to the service of the first network device, the first network device may further send service time information or service time offset information to the third network device. Details are described below.

In some embodiments, the first network device may send service time information to the third network device. The third network device receives the service time information from the first network device.

For descriptions of the service time information, refer to the descriptions of the service time information in S504. Details are not described herein again.

In some embodiments, the first network device may send the service time offset information to the third network device. The third network device receives the service time offset information from the first network device.

The service time offset information indicates an offset between a time period in which the first network device serves the anchor beam position (denoted as anchor service time information) and a time period in which the first network device serves the first beam position (denoted as the service time information). For example, the service time offset information may include a start time offset value and an end time offset value. For example, if the anchor service time information is [13:30, 14:30], it indicates that the time in which the first network device serves the anchor beam position is from 13:30 p.m. to 14:30 p.m . . . . If the start time offset value is 10 and the end time offset value is-30, it indicates that start time of the service time information is 10 minutes later than start time of the anchor service time information, namely, 13:40 p.m., and end time of the service time information is 30 minutes earlier than end time of the anchor service time information, namely, 14:00 p.m . . . . Therefore, the service time information is [13:40, 14:00].

It may be understood that the service time offset information may be a value obtained by subtracting the start time and the end time of the anchor service time information from the start time and the end time of the service time information respectively; or a value obtained by subtracting the start time and the end time of the service time information from the start time and the end time of the anchor service time information respectively. This is not limited.

In addition, the service time offset information one-to-one corresponds to the beam position on which interference scheduling is performed by the first network device. For example, when the first network device sends only one piece of beam position offset information, there is only one piece of service time offset information corresponding to the beam position offset information. Correspondingly, when the first network device sends a plurality of pieces of beam position offset information, there may also be a plurality of pieces of service time offset information, and the plurality of pieces of service time offset information respectively correspond to the plurality of pieces of beam position offset information.

The first network device may simultaneously send the service time offset information and the beam position offset information. In other words, the first network device may encapsulate the service time offset information and the beam position offset information into one message for sending. Alternatively, the service time offset information and the beam position offset information may be sent in sequence, that is, the first network device may encapsulate the service time offset information and the beam position offset information into different messages for sending. This is not limited.

It may be further understood that the anchor service time information may be used as reference information of the service time offset information, that is, service time corresponding to the service time offset information may be determined based on the anchor service time information. The “anchor service time information” mentioned in this embodiment of this application is merely an example expression, and may alternatively be replaced with any possible expression, for example, “reference service time information”, “anchor service time information”, or “preset service time information”. This is not limited.

In some embodiments, the first network device may further send the anchor service time information to the third network device. The third network device receives the anchor service time information from the first network device. For example, the anchor service time information is sent when the third network device does not store the anchor service time information, so that beam position information used as a reference by the two parties can be aligned. Certainly, if the anchor service time information is preconfigured in the third network device, the first network device may not send the anchor service time information to the third network device, to avoid communication redundancy.

After receiving the beam position offset information, the third network device may continue to perform S507.

S507: The third network device may determine, based on the beam position offset information, not to provide a service for a target area; or the third network device may indicate, based on the beam position offset information, the second network device not to provide a service for a target area.

It may be understood that, when it is determined not to provide the service for the target area, an exemplary implementation principle of a related device or related information in this case is similar to that in the foregoing embodiment. Refer to the foregoing embodiment for understanding. Details are not described herein again.

The third network device and the second network device may be a same device, or may be different devices. Therefore, when receiving the first beam position offset information, the third network device may perform different operations based on a relationship between the third network device and the second network device. The following separately provides descriptions.

In a possible embodiment, the third network device and the second network device are the same device, and the third network device may determine, based on the beam position offset information, not to provide the service for the target area.

In some embodiments, after receiving the beam position offset information, the third network device may determine the first beam position based on the second beam position information and the beam position offset information, then determine the target area based on the first beam position and the area covered by the beam of the third network device, and disable the beam that can cover the target area, to avoid a case in which the beam of the second network device affects service effect when the first network device provides the service for the terminal. In addition, a quantity of transmitted bits can be reduced by transmitting the beam position offset information, so that transmission overheads can be reduced.

In some embodiments, the third network device may determine, based on the beam position offset information and the anchor beam position information, not to provide the service for the target area.

In some embodiments, when receiving the anchor beam position information sent by the first network device, the third network device may obtain, based on the anchor beam position information and with reference to the beam position offset information, the first beam position information and the first beam position indicated by the first beam position information, determine the target area based on the first beam position, and disable the beam that can irradiate the target area.

For example, the anchor beam position information received by the third network device is 101523, that is, first-level information is 10, second-level information is 15, and third-level information is 23. In addition, the received beam position offset information is [0, 0, 1], that is, offset values of the first beam position information relative to the first-level information, the second-level information, and the third-level information of the anchor beam position information are 0, 0, and 1 respectively. Therefore, the first beam position information is 101524. The third network device may determine, by searching for the first beam position whose beam position information is 101524, that an area in which the area covered by the beam of the third network device overlaps the first beam position is the target area, and disable a beam that can irradiate the target area.

In some embodiments, the third network device may determine, based on the beam position offset information and the service time information, not to provide the service for the target area in the time in which the first network device provides the service for the first beam position, to disable, in the time period corresponding to the service time information, the beam that affects the target area, and use of the beam after the time period is not affected.

For example, if the anchor beam position information is three-level information of 081010, the beam position offset information is [1, 1, 2], and the service time information is [10:00, 15:00], it indicates that the first network device provides, from 10:00 a.m. to 15:00 p.m., a service for a beam position whose beam position information is 091112. Correspondingly, the third network device may determine to disable, from 10:00 a.m. to 15:00 p.m., a beam that affects the beam position whose beam position information is 091112.

In some embodiments, the third network device may determine, based on the service time offset information, not to provide the service for the target area in the time in which the first network device provides the service for the first beam position, to make the second network device disable the beam on time.

It may be understood that the time period in which the first network device serves the anchor beam position may be preset in the third network device, that is, the anchor service time information is preset in the third network device. In addition, the third network device may determine, based on the service time offset information received each time with reference to the anchor service time information, complete service time information corresponding to the service time offset information.

For example, if the anchor service time information is [13:40, 15:30], and the service time offset information is [10, 70], it indicates that start time at which the first network device serves the first beam position is 10 minutes later than start time at which the first network device serves the anchor beam position, end time at which the first network device serves the first beam position is 70 minutes later than end time at which the first network device serves the anchor beam position. In other words, the start time and the end time at which the first network device serves the first beam position is 13:50 p.m. and 16:40 p.m. respectively. Therefore, a time period in which the first network device serves the first beam position is [13:50, 16:40], that is, the service time information is [13:50, 16:40].

In some embodiments, the third network device may determine, based on the beam position offset information, the service time offset information, and the anchor service time information, not to provide the service for the target area in the time in which the first network device provides the service for the first beam position.

In some embodiments, after receiving the beam position offset information, the service time offset information, and the anchor service time information that are sent by the first network device, the third network device may first determine the target area based on the beam position offset information and the preconfigured anchor beam position information, and determine the service time information based on the service time offset information and the anchor service time information, to disable the beam that affects the target area in the time period corresponding to the service time information, and use of the beam after the time period is not affected.

In some embodiments, the third network device and the second network device are different devices, and the third network device is configured to schedule the second network device. The third network device may indicate, based on the beam position offset information, the second network device not to provide the service for the target area.

It may be understood that the relationship between the third network device and the second network device may be different in the case 2. For example, when the third network device and the second network device are the same device, the third network device makes a scheduling decision, and executes a decision result. When the third network device and the second network device are different devices, the third network device is configured to schedule the second network device, that is, the third network device makes the scheduling decision, and sends the scheduling decision to the second network device, for the second network device to execute the scheduling decision. It can be learned that, when the third network device and the second network device are different devices, receiving and sending operations and processing operations performed by the third network device are the same as those performed by the third network device when the third network device and the second network device are the same device, and a difference lies in that the third network device may indicate the second network device to execute the corresponding decision result. Therefore, for the operations of the third network device, refer to the related descriptions of the receiving and sending operations and the processing operations performed by the third network device when the third network device and the second network device are the same device. Details are not described herein again.

It may be further understood that the foregoing embodiment is merely an example, and no limitation is imposed. For example, when the first network device needs to perform interference scheduling, the first network device may send, to the third network device, beam position offset information of a beam position on which interference scheduling needs to be performed. In addition, when there are a plurality of beam positions on which interference scheduling needs to be performed, the first network device may send beam position offset information of the plurality of beam positions to the third network device, to implement interference scheduling on the plurality of beam positions. For another example, to make the second network device disable, on time, a beam that generates interference, the first network device may further send, when sending, to the third network device, the beam position offset information of the beam position on which interference scheduling needs to be performed, service time information or service time offset information corresponding to the beam position; or when sending the beam position offset information of the plurality of beam positions to the third network device, the first network device may send a plurality of pieces of service time information or a plurality of pieces of service time offset information corresponding to the plurality of beam positions. The following separately provides descriptions.

In some embodiments, when there are a plurality of beam positions on which interference scheduling needs to be performed, the first network device may send beam position information of any one of the plurality of beam positions (denoted as anchor beam position information) to the third network device, and beam position offset information of beam position information that is of a remaining beam position other than the any one of the plurality of beam positions and that is relative to the anchor beam position information.

For example, beam position information of beam positions on which interference scheduling needs to be performed is three-level information of 013421, 063529, 103728, and 121941. The first network device may set 013421 as the anchor beam position information, and transmit the beam position information of 013421 and three pieces of beam position offset information of [5, 1, 8], [9, 3, 7], and [11, −15, 20]. Alternatively, the first network device may set 063529 as the anchor beam position information, and transmit the beam position information of 063529 and three pieces of beam position offset information [−5, −1, −8], [4, 2, −1], and [6, −16, 12].

In some embodiments, the first network device may further send the plurality of pieces of service time information corresponding to the plurality of beam positions; or send the anchor service time information corresponding to the anchor beam position information, and each piece of service time offset information corresponding to the beam position offset information of the beam position information that is of the remaining beam position in the plurality of beam positions and that is relative to the anchor beam position information. The service time offset information uses the anchor service time information a reference.

For example, if the anchor beam position information is 010101, the anchor service time information is [13:40, 15:30], a plurality of pieces of beam position offset information received by the third network device are [0, 0, 1], [1, 1, 2], and [3, 2, 2] respectively, and a plurality of pieces of service time offset information are [0, 0], [−20, 60], and [0, −40] respectively, it indicates that the first network device serves a beam position whose beam position information is 010102 in a time period from 13:40 p.m. to 15:30 p.m., serves a beam position whose beam position information is 020203 in a time period from 13:20 p.m. to 16:30 p.m., and serves a beam position whose beam position information is 040303 in a time period from 13:40 p.m. to 14:50 p.m.

It may be understood that the first network device may mark the plurality of pieces of sent beam position offset information and the plurality of pieces of service time information or the plurality of pieces of service time offset information, to ensure that each piece of beam position offset information one-to-one corresponds to each piece of service time information or each piece of service time offset information. For example, each piece of beam position offset information may one-to-one correspond to each piece of service time information or each piece of service time offset information in a transmission sequence. This is not limited.

It may be further understood that, when sending, to the third network device a plurality of consecutive times, the beam position information on which interference scheduling needs to be performed, the first network device may send, during sending for the first time, beam position information of one beam position (denoted as the anchor beam position information) and offset information of another beam position relative to the anchor beam position information; or only send beam position information of one beam position, namely, the anchor beam position information. In addition, in each subsequent sending, each piece of sent beam position offset information uses the anchor beam position information as a reference.

For example, information sent by the first network device to the third network device for the first time is 011933 and [1, 2, 3], where 011933 indicates beam position information of a beam position on which interference scheduling needs to be performed, namely, the anchor beam position information, 01 is first-level information, 19 is second-level information, and 33 is third-level information, [1, 2, 3] is beam position offset information of a beam position on which interference scheduling needs to be performed, and [1, 2, 3] is offset information obtained by using 011933 as the anchor beam position information, that is, beam position information corresponding to [1, 2, 3] is 022136. Information sent by the second network device to the third network device for the second time is [5, 1, 7], where [5, 1, 7] is offset information obtained by using 011933 as the anchor beam position information, that is, beam position information corresponding to [5, 1, 7] is 062040. Information sent by the second network device to the third network device for the third time is [1, 2, 2] and [4, 7, 8], where both [1, 2, 2] and [4, 7, 8] are offset information obtained by using 011933 as the anchor beam position information, that is, beam position information corresponding to [1, 2, 2] is 022135, and beam position information corresponding to [4, 7, 8] is 052641.

In addition, when sending, to the third network device a plurality of consecutive times, the service time offset information corresponding to the beam position on which interference scheduling needs to be performed, the first network device may send, during sending for the first time, service time information of one beam position (denoted as the anchor service time information) and service time offset information of another beam position relative to the anchor service time information; or only send service time information of one beam position, namely, the anchor service time information. In addition, in each subsequent sending, the sent service time offset information of each beam position uses the anchor service time information as a reference.

The communication method provided in embodiments of this application is described above in detail with reference to FIG. 5 to FIG. 10. Communication apparatuses configured to perform the communication method provided in embodiments of this application are described below in detail with reference to FIG. 5 to FIG. 10.

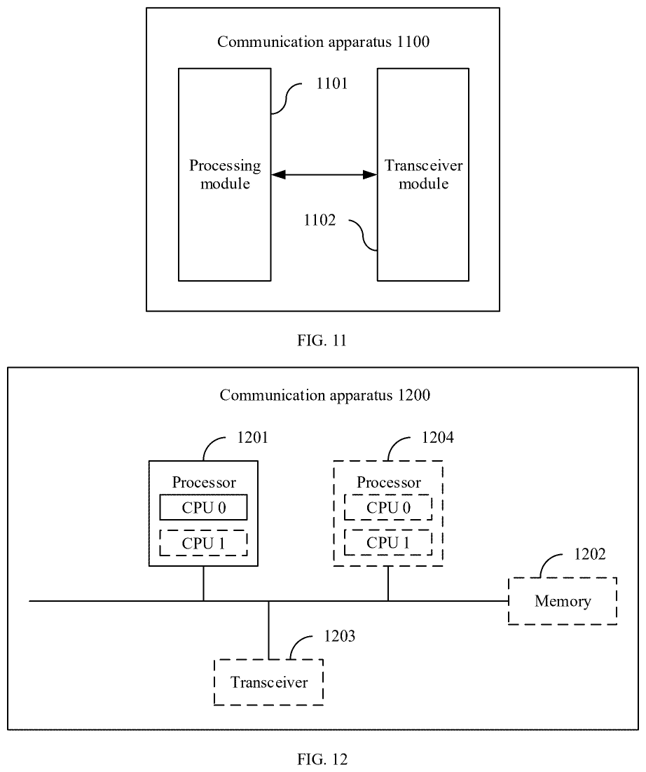

FIG. 11 is a diagram 1 of a structure of a communication apparatus according to an embodiment of this application. For example, as shown in FIG. 11, the communication apparatus 1100 includes a processing module 1101 and a transceiver module 1102. For ease of description, FIG. 11 shows only main components of the communication apparatus.

In some embodiments, the communication apparatus 1100 may be used in the communication system shown in FIG. 4, and perform a function of the foregoing terminal.

For example, the processing module 1101 is configured to obtain first beam position information, where the first beam position information includes N-level information in M-level information indicating a first beam position, i^{th}-level information in the M-level information indicates an i^{th}-level area, (i+1)^{th}-level information in the M-level information indicates an (i+1)^{th}-level area, M is an integer greater than 1, N is an integer less than or equal to M, i is any integer from 1 to M-1, the i^{th}-level area includes the (i+1)^{th}-level area, the (i+1)^{th}-level area includes the first beam position, and the first beam position includes a beam position in which the terminal is located or a beam position to which the terminal is capable of moving. The transceiver module 1102 is configured to send the first beam position information to a first network device, where an area covered by a beam of the first network device includes the first beam position.

In some embodiments, the transceiver module 1102 is further configured to send the first beam position information to the first network device when determining that the terminal has moved to the first beam position or the terminal is capable of moving to the first beam position.

In some embodiments, the transceiver module 1102 is further configured to send the first beam position information to the first network device when determining that the terminal needs to obtain a service of the first network device.

In some embodiments, the transceiver module 1102 is further configured to receive the first beam position information broadcast by the first network device.

In some embodiments, the transceiver module 1102 is further configured to receive area information from the first network device, where the area information is used to determine the area covered by the beam of the first network device. The processing module 1101 is further configured to determine the first beam position information based on the area information and a position of the terminal and according to a preset rule, where the preset rule indicates that beam positions in the area covered by the beam of the first network device are obtained through division based on M-level areas.

In some embodiments, the transceiver module 1102 is further configured to receive beam position set information from the first network device, where the beam position set information indicates position distribution of a plurality of beam positions, and the first beam position belongs to the plurality of beam positions; and the processing module 1101 is further configured to determine the first beam position information based on the position distribution of the plurality of beam positions and the position of the terminal.

In some embodiments, areas at a same level that include any two of the plurality of beam positions have a same size.

In some embodiments, areas at a same level that include any two of the plurality of beam positions have different sizes.

In some embodiments, the transceiver module 1102 may include a sending module (not shown in FIG. 11) and a receiving module (not shown in FIG. 11). The sending module is configured to implement a sending function of the communication apparatus 1100, and the receiving module is configured to implement a receiving function of the communication apparatus 1100.

In some embodiments, the communication apparatus 1100 may further include a storage module (not shown in FIG. 11), and the storage module stores a program or instructions. When the processing module 1101 executes the program or the instructions, the communication apparatus 1100 is enabled to perform the function of the terminal in the method shown in FIG. 5 to FIG. 10 in the foregoing method.

It may be understood that the communication apparatus 1100 may be a terminal, for example, remote UE or a remote device, may be a chip (system) or another part or component that may be disposed in the terminal, or may be an apparatus including the terminal. This is not limited in this application. It may be understood that if the communication apparatus 1100 is a chip (system) disposed in a device, the transceiver module may be an input/output interface of the chip (system), for example, an input/output circuit or a pin.

In addition, for technical effect of the communication apparatus 1100, refer to the technical effect of the communication method shown in FIG. 5 to FIG. 10. Details are not described herein again.

In some other embodiments, the communication apparatus 1100 may be used in the communication system shown in FIG. 4, and perform a function of the foregoing first network device.

In some embodiments, the transceiver module 1102 is configured to receive first beam position information from a terminal, where the first beam position information includes N-level information in M-level information indicating a first beam position, i^{th}-level information in the M-level information indicates an i^{th}-level area, (i+1)^{th}-level information in the M-level information indicates an (i+1)^{th}-level area, M is an integer greater than 1, N is an integer less than or equal to M, i is any integer from 1 to M-1, the i^{th}-level area includes the (i+1)^{th}-level area, the (i+1)^{th}-level area includes the first beam position, and the first beam position includes a beam position in which the terminal is located or a beam position to which the terminal is capable of moving; and the processing module 1101 is configured to store the first beam position information.

In some embodiments, the transceiver module 1102 is further configured to send the first beam position information to a third network device when an area covered by a beam of a second network device overlaps the first beam position. The third network device and the second network device are a same device, or the third network device is configured to schedule the second network device.

In some embodiments, the transceiver module 1102 is further configured to send position information of the first network device to the third network device.

Further, the transceiver module 1102 is further configured to send the position information of the first network device to the third network device when the first beam position information indicates that there are a plurality of first beam positions.

In some embodiments, the transceiver module 1102 is further configured to send beam position offset information to a third network device when an area covered by a beam of a second network device overlaps the first beam position. The third network device and the second network device are a same device, or the third network device is configured to schedule the second network device, and the beam position offset information indicates an offset between the first beam position and an anchor beam position.

In some embodiments, the transceiver module 1102 is further configured to send anchor beam position information to the third network device, where the anchor beam position information includes M-level information indicating the anchor beam position, j^{th}-level information in the M-level information of the anchor beam position indicates a j^{th}-level area, (j+1)^{th}-level information in the M-level information of the anchor beam position indicates a (j+1)^{th}-level area, j is any integer from 1 to M-1, the j^{th}-level area includes the (j+1)^{th}-level area, and the (j+1)^{th}-level area includes the anchor beam position.

In some embodiments, the transceiver module 1102 is further configured to send service time information to the third network device, where the service time information is used to determine time in which the first network device provides a service for the beam position in which the terminal is located or the beam position to which the terminal is capable of moving.

In some embodiments, the transceiver module 1102 may include a sending module (not shown in FIG. 11) and a receiving module (not shown in FIG. 11). The sending module is configured to implement a sending function of the communication apparatus 1100, and the receiving module is configured to implement a receiving function of the communication apparatus 1100.

In some embodiments, the communication apparatus 1100 may further include a storage module (not shown in FIG. 11), and the storage module stores a program or instructions. When the processing module 1101 executes the program or the instructions, the communication apparatus 1100 is enabled to perform the function of the terminal in the method shown in FIG. 5 to FIG. 10 in the foregoing method.

It may be understood that the communication apparatus 1100 may be a terminal, for example, remote UE or a remote device, may be a chip (system) or another part or component that may be disposed in the terminal, or may be an apparatus including the terminal. This is not limited in this application. It may be understood that if the communication apparatus 1100 is a chip (system) disposed in a device, the transceiver module may be an input/output interface of the chip (system), for example, an input/output circuit or a pin.

In addition, for technical effect of the communication apparatus 1100, refer to the technical effect of the communication method shown in FIG. 5 to FIG. 10. Details are not described herein again.

FIG. 12 is a diagram 2 of a structure of a communication apparatus according to an embodiment of this application. For example, the communication apparatus may be a terminal, or may be a chip (system) or another part or component that may be disposed in the terminal. As shown in FIG. 12, the communication apparatus 1200 may include a processor 1201. In some embodiments, the communication apparatus 1200 may further include a memory 1202 and/or a transceiver 1203. The processor 1201 is coupled to the memory 1202 and the transceiver 1203, for example, may be connected to the memory 1202 and the transceiver 1203 through a communication bus.

The following describes the components of the communication apparatus 1200 in detail with reference to FIG. 12.

The processor 1201 is a control center of the communication apparatus 1200, and may be one processor or may be a collective term of a plurality of processing elements. For example, the processor 1201 is one or more central processing units (CPUs), may be an application-specific integrated circuit (ASIC), or is configured as one or more integrated circuits for implementing embodiments of this application, for example, one or more microprocessors (DSPs) or one or more field programmable gate arrays (FPGAs).

In some embodiments, the processor 1201 may perform various functions of the communication apparatus 1200, for example, perform the communication method shown in FIG. 5 to FIG. 10, by running or executing a software program stored in the memory 1202 and invoking data stored in the memory 1202.

In some embodiments, the processor 1201 may include one or more CPUs, for example, a CPU 0 and a CPU 1 shown in FIG. 12.

In some embodiments, the communication apparatus 1200 may also include a plurality of processors, for example, the processor 1201 and a processor 1204 shown in FIG. 12. Each of the processors may be a single-core processor (single-CPU), or may be a multi-core processor (multi-CPU). The processor herein may be one or more devices, circuits, and/or processing cores configured to process data (for example, computer program instructions).

The memory 1202 is configured to store a software program for executing the solutions of this application, and the processor 1201 controls execution. For an exemplary embodiment, refer to the foregoing method embodiments. Details are not described herein again.

In some embodiments, the memory 1202 may be a read-only memory (ROM), another type of static storage device that can store static information and instructions, a random access memory (RAM), or another type of dynamic storage device that can store information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, or the like), a magnetic storage medium or another magnetic storage device, or any other medium that can be used to carry or store expected program code in a form of instructions or a data structure and that can be accessed by a computer. However, this is not limited thereto. The memory 1202 may be integrated with the processor 1201, or may exist independently, and is coupled to the processor 1201 through an interface circuit (not shown in FIG. 12) of the communication apparatus 1200. This is not limited in embodiments of this application.

The transceiver 1203 is configured to communicate with another communication apparatus. For example, the communication apparatus 1200 is a terminal, and the transceiver 1203 may be configured to communicate with a network device or communicate with another terminal device. For another example, the communication apparatus 1200 is a network device, and the transceiver 1203 may be configured to communicate with a terminal or communicate with another network device.

In some embodiments, the transceiver 1203 may include a receiver and a transmitter (not separately shown in FIG. 12). The receiver is configured to implement a receiving function, and the transmitter is configured to implement a sending function.

In some embodiments, the transceiver 1203 may be integrated with the processor 1201, or may exist independently, and is coupled to the processor 1201 through an interface circuit (not shown in FIG. 12) of the communication apparatus 1200. This is not limited in embodiments of this application.

It may be understood that the structure of the communication apparatus 1200 shown in FIG. 12 does not constitute a limitation on the communication apparatus. An actual communication apparatus may include more or fewer components than those shown in the figure, a combination of some components, or a different component layout.

In addition, for technical effect of the communication apparatus 1200, refer to the technical effect of the method in the foregoing method embodiment. Details are not described herein again.

It should be understood that, the processor in embodiments of this application may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be understood that the memory in embodiments of this application may be a volatile memory or a nonvolatile memory, or may include a volatile memory and a nonvolatile memory. The nonvolatile memory may be a read-only memory (ROM), a programmable read-only memory (, PROM), an erasable programmable read-only memory (EPROM), an electrically erasable programmable read-only memory (, EEPROM), or a flash memory. The volatile memory may be a random access memory (RAM), and is used as an external cache. Through example but not limitative descriptions, many forms of random access memories (RAMs) may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented by software, hardware (for example, a circuit), firmware, or any combination thereof. When software is used to implement embodiments, all or some of the embodiments may be implemented in a form of a computer program product. The computer program product includes one or more computer instructions or computer programs. When the computer instructions or the computer programs are loaded and executed on the computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium (for example, a DVD), or a semiconductor medium. The semiconductor medium may be a solid-state drive.

It should be understood that a term “and/or” in this specification describes only an association relationship between associated objects and indicates that three relationships may exist. For example, A and/or B may indicate the following three cases: Only A exists, both A and B exist, and only B exists, where A and B may be singular or plural. In addition, a character “/” in this specification usually indicates an “or” relationship between the associated objects, but may alternatively indicate an “and/or” relationship. For details, refer to the context for understanding.

In this application, “at least one” means one or more, and “a plurality of” means two or more. “At least one of the following items (pieces)” or a similar expression thereof indicates any combination of these items, including a single item (piece) or any combination of a plurality of items (pieces). For example, at least one of a, b, or c may indicate: a, b, c, a-b, a-c, b-c, or a-b-c, where a, b, and c may be singular or plural.

It should be understood that, in embodiments of this application, sequence numbers of the foregoing processes do not mean execution sequences. The execution sequences of the processes should be determined based on functions and internal logic of the processes, and should not constitute any limitation on operations or processes of embodiments of this application.

A person of ordinary skill in the art may be aware that units and algorithm operations in the examples described with reference to embodiments disclosed in this specification can be implemented by electronic hardware, or a combination of computer software and electronic hardware. Whether the functions are performed by hardware or software depends on particular applications and embodiment constraints of the technical solutions. A person skilled in the art may use different methods to implement the described functions for each particular application, but it should not be considered that the embodiment goes beyond the scope of this application.

A person skilled in the art may clearly understand that, for convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in an actual embodiment. For example, a plurality of units or components may be combined or integrated into another system, or some features may be ignored or not performed. In addition, the displayed or discussed mutual couplings or direct couplings or communication connections may be implemented through some interfaces.

The indirect couplings or communication connections between the apparatuses or units may be implemented in an electronic form, a mechanical form, or another form.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of embodiments of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the operations of the methods described in embodiments of this application. The foregoing storage medium includes any medium that can store program code, such as a USB flash drive, a removable hard disk, a read-only memory (ROM), a random access memory () a magnetic disk, or an optical disc.

The foregoing descriptions are merely exemplary embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
obtaining, by a terminal, first beam position information, the first beam position information comprising N-level information in M-level information indicating a first beam position, i^{th}-level information in the M-level information indicating an i^{th}-level area, and (i+1)^{th}-level information in the M-level information indicating an (i+1)^{th}-level area, wherein M is an integer greater than 1, N is an integer less than or equal to M, i is any an integer from 1 to M-1, the i^{th}-level area comprises the (i+1)^{th}-level area, the (i+1)^{th}-level area comprises the first beam position, and the first beam position comprises a beam position in which the terminal is located or a beam position to which the terminal is capable of moving; and
sending, by the terminal, the first beam position information to a first network device, wherein an area covered by a beam of the first network device comprises the first beam position.

2. The method according to claim 1, wherein sending, by the terminal, the first beam position information to the first network device comprises:
sending, by the terminal, the first beam position information to the first network device when the terminal determines that the terminal has moved to the first beam position or the terminal is capable of moving to the first beam position.

3. The method according to claim 1, wherein sending, by the terminal, the first beam position information to the first network device comprises:
sending, by the terminal, the first beam position information to the first network device when the terminal determines that the terminal needs to obtain a service of the first network device.

4. The method according to claim 1, wherein obtaining, by the terminal, the first beam position information comprises:
receiving, by the terminal, the first beam position information broadcast by the first network device.

5. The method according to claim 1, wherein obtaining, by the terminal, the first beam position information comprises:
receiving, by the terminal, area information from the first network device, wherein the area information is used to determine the area covered by the beam of the first network device; and
determining, by the terminal, the first beam position information based on the area information and a position of the terminal and according to a preset rule, wherein the preset rule indicates that beam positions in the area covered by the beam of the first network device are obtained through division based on M-level areas.

6. The method according to claim 1, wherein obtaining, by the terminal, the first beam position information comprises:
receiving, by the terminal, beam position set information from the first network device, wherein the beam position set information indicates position distribution of a plurality of beam positions, and the first beam position belongs to the plurality of beam positions; and
determining, by the terminal, the first beam position information based on the position distribution of the plurality of beam positions and a position of the terminal.

7. An apparatus, comprising:
at least one processor; and
one or more memories coupled to the at least one processor and storing program instructions for execution by the at least one processor to cause the apparatus to:
obtain first beam position information associated with a terminal, the first beam position information comprising N-level information in M-level information indicating a first beam position, i^{th}-level information in the M-level information indicating an i^{th}-level area, and (i+1)^{th}-level information in the M-level information indicating an (i+1)^{th}-level area, wherein M is an integer greater than 1, N is an integer less than or equal to M, i is an integer from 1 to M-1, the i^{th}-level area comprises the (i+1)^{th}-level area, the (i+1)^{th}-level area comprises the first beam position, and the first beam position comprises a beam position in which the terminal is located or a beam position to which the terminal is capable of moving; and
send the first beam position information to a first network device, wherein an area covered by a beam of the first network device comprises the first beam position.

8. The apparatus according to claim 7, wherein to send the first beam position information to the first network device the apparatus is caused to:
send the first beam position information to the first network device when the terminal determines that the terminal has moved to the first beam position or the terminal is capable of moving to the first beam position.

9. The apparatus according to claim 7, wherein to send the first beam position information to the first network device the apparatus is caused to:
send the first beam position information to the first network device when the terminal determines that the terminal needs to obtain a service of the first network device.

10. The apparatus according to claim 7, wherein to obtain the first beam position information the apparatus is caused to:
receive the first beam position information broadcast by the first network device.

11. The apparatus according to claim 7, wherein to obtain the first beam position information the apparatus is caused to:
receive area information from the first network device, wherein the area information is used to determine the area covered by the beam of the first network device; and
determine the first beam position information based on the area information and a position of the terminal and according to a preset rule, wherein the preset rule indicates that beam positions in the area covered by the beam of the first network device are obtained through division based on M-level areas.

12. The apparatus according to claim 7, wherein to obtain the first beam position information the apparatus is caused to:
receive beam position set information from the first network device, wherein the beam position set information indicates position distribution of a plurality of beam positions, and the first beam position belongs to the plurality of beam positions; and
determine the first beam position information based on the position distribution of the plurality of beam positions and a position of the terminal.

13. The apparatus according to claim 12, wherein areas at a same level that comprise at least two of the plurality of beam positions have a same size or different sizes.

14. An apparatus, comprising:
at least one processor; and
one or more memories coupled to the at least one processor and storing program instructions for execution by the at least one processor to cause the apparatus to:
receive first beam position information from a terminal, the first beam position information comprising N-level information in M-level information indicating a first beam position, i^{th}-level information in the M-level information indicating an i^{th}-level area, and (i+1)^{th}-level information in the M-level information indicating an (i+1)^{th}-level area, wherein M is an integer greater than 1, N is an integer less than or equal to M, i is any an integer from 1 to M-1, the i^{th}-level area comprises the (i+1)^{th}-level area, the (i+1)^{th}-level area comprises the first beam position, and the first beam position comprises a beam position in which the terminal is located or a beam position to which the terminal is capable of moving; and
store the first beam position information.

15. The apparatus according to claim 14, wherein the one or more memories further storing program instructions for execution by the at least one processor to cause the apparatus to:
send the first beam position information to a third network device when an area covered by a beam of a second network device overlaps the first beam position, wherein the third network device and the second network device are a same device, or the third network device is configured to schedule the second network device.

16. The apparatus according to claim 15, wherein the one or more memories further storing program instructions for execution by the at least one processor to cause the apparatus to:
send position information of the first network device to the third network device.

17. The apparatus according to claim 16, wherein to send the position information of the first network device to the third network device the apparatus is caused to:
send the position information of the first network device to the third network device when the first beam position information indicates that there are a plurality of first beam positions.

18. The apparatus according to claim 14, wherein the one or more memories further storing program instructions for execution by the at least one processor to cause the apparatus to:
send beam position offset information to a third network device when an area covered by a beam of a second network device overlaps the first beam position, wherein the third network device and the second network device are a same device, or the third network device is configured to schedule the second network device, and the beam position offset information indicates an offset between the first beam position and an anchor beam position.

19. The apparatus according to claim 18, wherein the one or more memories further storing program instructions for execution by the at least one processor to cause the apparatus to:
send anchor beam position information to the third network device, the anchor beam position information comprising M-level information indicating the anchor beam position, j^{th}-level information in the M-level information of the anchor beam position indicating a j^{th}-level area, and (j+1)^{th}-level information in the M-level information of the anchor beam position indicates-indicating a (j+1)^{th}-level area, wherein j is any integer from 1 to M-1, the j^{th}-level area comprises the (j+1)^{th}-level area, and the (j+1)^{th}-level area comprises the anchor beam position.

20. The apparatus according to claim 15, wherein the one or more memories further storing program instructions for execution by the at least one processor to cause the apparatus to:
send service time information to the third network device, wherein the service time information is used to determine time in which the first network device provides a service for the first beam position.
